(19) United States
(12) Patent Application Publication
(10) Pub. No.: US 2024/0419884 A1
(43) Pub. Date: Dec. 19, 2024

(54) COMPUTING SYSTEM AND INTEGRATED CIRCUIT DESIGN SYSTEM USING THE SAME

(71) Applicant: Samsung Electronics Co., Ltd., Suwon-si (KR)

(72) Inventors: Yeon Il JUNG, Suwon-si (KR); Han-Kyung KIM, Suwon-si (KR); Seung Kwon LEE, Suwon-si (KR)

(21) Appl. No.: 18/631,815

(22) Filed: Apr. 10, 2024

(30) Foreign Application Priority Data
Jun. 19, 2023 (KR) 10-2023-0078022

(51) Int. Cl. G06F 30/3953

(52) U.S. Cl. CPC G06F 30/3953

(57) ABSTRACT

An integrated circuit design system using a computing system comprises a processor, and memory configured to store an instruction, which allows the processor to perform a method of designing an integrated circuit, the integrated circuit includes a substrate, a front end of line (FEOL) in at least a portion of the substrate and on the substrate, and a back end of line (BEOL) formed on the FEOL, and the method of designing the integrated circuit includes selecting a first metal layer included in the BEOL and disposed at a first level from the substrate, generating a first blockage layer disposed at the first level, surrounding the first metal layer, generating at least one first upper blockage layer disposed at a level higher than the first level from the substrate, and generating at least one first lower blockage layer disposed at a level lower than the first level from the substrate.

### CROSS-REFERENCE TO RELATED APPLICATION

This application claims priority and all the benefits accruing therefrom under 35 U.S.C. § 119 from Korean Patent Application No. 10-2023-0078022, filed on Jun. 19, 2023, in the Korean Intellectual Property Office, the contents of which in its entirety are herein incorporated by reference.

### BACKGROUND

### Technical Field

The present disclosure relates to a computing system and an integrated circuit design system using the same.

### Description of the Related Art

Fine processes have been developed for the development of semiconductor chip technology. In addition, a width between metal layers of an integrated circuit (IC) has continued to be reduced to improve the degree of integration of the integrated circuit and reduce a size of a chip. In particular, dummy patterns may be added between metal layers, to which electrical signals are actually routed, to prevent dishing that occurs during a chemical mechanical polishing (CMP) process. In this case, parasitic capacitance may be increased between the metal layer and the dummy pattern, resulting in performance loss of the integrated circuit.

### BRIEF SUMMARY

An object of the present disclosure is to provide an integrated circuit design system using a computing system in which reliability is improved.

Another object of the present disclosure is to provide a computing system in which reliability is improved.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided an integrated circuit design system using a computing system, the integrated circuit design system comprising: a memory configured to store an instruction; and a processor configured to execute the instruction to cause the integrated circuit design system to design an integrated circuit, wherein the integrated circuit includes a substrate, a front end of line (FEOL) in at least a portion of the substrate and on the substrate, and a back end of line (BEOL) formed on the FEOL, and wherein when the processor executes the instruction to cause the integrated circuit design system to design the integrated circuit, the processor is configured to: select a first metal layer included in the BEOL and disposed at a first level from the substrate; generate a first blockage layer disposed at the first level and surrounding the first metal layer; generate at least one first upper blockage layer disposed at a level higher than the first level from the substrate; and generate at least one first lower blockage layer disposed at a level lower than the first level from the substrate.

According to an aspect of the present disclosure, there is provided an integrated circuit design system using a computing system, the integrated circuit design system comprising: a memory configured to store an instruction; and a processor configured to execute the instruction to cause the integrated circuit design system to design an integrated circuit, wherein the integrated circuit includes a substrate, a front end of line (FEOL) in at least a portion of the substrate and on the substrate, a back end of line (BEOL) formed on the FEOL, and a passive element formed in the BEOL, wherein the passive element includes a first metal layer included in the BEOL and disposed at a first level from the substrate, and a second metal layer included in the BEOL, disposed at a second level higher than the first level from the substrate and connected to the first metal layer through a via, and wherein when the processor executes the instruction to cause the integrated circuit design system to design the integrated circuit, the processor is configured to: select the first metal layer; generate a first blockage layer disposed at the first level, surrounding the first metal layer; generate a second blockage layer disposed at the second level, surrounding the second metal layer; generate at least one upper blockage layer disposed at a level higher than the second level from the substrate; and generate at least one lower blockage layer disposed at a level lower than the first level from the substrate.

According to an aspect of the present disclosure, there is provided a computing system a memory configured to store an instruction; and a processor configured to execute the instruction to cause the computing system to design an integrated circuit, wherein the integrated circuit includes a substrate, a front end of line (FEOL) formed in at least a portion of the substrate and on the substrate and a back end of line (BEOL) formed on the FEOL, wherein when the processor executes the instruction to cause the computing system to design the integrated circuit, the processor is configured to: select a first metal layer included in the BEOL and disposed at a first level from the substrate; generate a first blockage layer disposed at the first level, and surrounding the first metal layer; generate at least one first upper blockage layer disposed at a level higher than the first level from the substrate; generate at least one first lower blockage layer disposed at a level lower than the first level from the substrate; select a passive element, which includes a second metal layer that is included in the BEOL, is disposed at the first level from the substrate, and does not overlap the first metal layer, and a third metal layer that is included in the BEOL, is disposed at a second level that is higher than the first level from the substrate, and is connected to the second metal layer through a via; generate a second blockage layer disposed at the first level, and surrounding the second metal layer; generate a third blockage layer disposed at the second level, and surrounding the third metal layer; generate at least one second upper blockage layer disposed at a level higher than the second level from the substrate; and generate at least one second lower blockage layer disposed at a level lower than the first level from the substrate.

According to an aspect of the present disclosure, there is provided a method comprising: of designing an integrated circuit, including a substrate, a front end of line (FEOL) in at least a portion of the substrate and on the substrate, and a back end of line (BEOL) formed on the FEOL, the method comprising: selecting a first metal layer included in the BEOL and disposed at a first level from the substrate; generating a first blockage layer disposed at the first level, surrounding the first metal layer; generating at least one first upper blockage layer disposed at a level higher than the first level from the substrate; and generating at least one first lower blockage layer disposed at a level lower than the first level from the substrate.

According to an aspect of the present disclosure, there is provided a method of designing an integrated circuit, including a substrate, a front end of line (FEOL) in at least a portion of the substrate and on the substrate, a back end of line (BEOL) formed on the FEOL, and a passive element formed in the BEOL, the method comprising: selecting a first metal layer, which is included in the BEOL and disposed at a first level from the substrate; generating a first blockage layer disposed at the first level, and surrounding the first metal layer; generating a second blockage layer disposed at the second level, and surrounding a second metal layer, which is included in the BEOL, disposed at a second level higher than the first level from the substrate, and connected to the first metal layer through a via; generating at least one upper blockage layer disposed at a level higher than the second level from the substrate; and generating at least one lower blockage layer disposed at a level lower than the first level from the substrate.

According to an aspect of the present disclosure, there is provided a method of designing an integrated circuit, including a substrate, a front end of line (FEOL) formed in at least a portion of the substrate and on the substrate and a back end of line (BEOL) formed on the FEOL, the method comprising: selecting a first metal layer included in the BEOL and disposed at a first level from the substrate; generating a first blockage layer disposed at the first level, surrounding the first metal layer; generating at least one first upper blockage layer disposed at a level higher than the first level from the substrate; generating at least one first lower blockage layer disposed at a level lower than the first level from the substrate; selecting a passive element, which includes a second metal layer that is included in the BEOL, is disposed at the first level from the substrate, and does not overlap the first metal layer, and a third metal layer that is included in the BEOL, is disposed at a second level that is higher than the first level from the substrate, and is connected to the second metal layer through a via; generating a second blockage layer disposed at the first level, surrounding the second metal layer; generating a third blockage layer disposed at the second level, surrounding the third metal layer; generating at least one second upper blockage layer disposed at a level higher than the second level from the substrate; and generating at least one second lower blockage layer disposed at a level lower than the first level from the substrate.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary view illustrating an integrated circuit design system using a computing system according to example embodiments.

FIGS. 2 and 3 are exemplary flow charts illustrating a method for designing an integrated circuit by using the design system of FIG. 1 according to example embodiments.

FIGS. 4 to 16 are exemplary views illustrating a method for designing an integrated circuit by using the design system of FIG. 1 according to example embodiments.

FIGS. 17 to 19 are exemplary views illustrating a method of designing an integrated circuit by using the system of FIG. 1 according to example embodiments.

FIGS. 20 to 22 are exemplary views illustrating an effect of an integrated circuit fabricated in accordance with example embodiments.

FIG. 23 is an exemplary flow chart illustrating a method for fabricating an integrated circuit in accordance with example embodiments.

FIG. 24 is an exemplary schematic view illustrating a semiconductor device that includes the integrated circuit fabricated in accordance with FIG. 23.

FIG. 25 is an exemplary block view illustrating the integrated circuit fabricated in accordance with FIG. 23.

### DETAILED DESCRIPTION OF THE DISCLOSURE

Hereinafter, a computing system and an integrated circuit design system using the same according to some embodiments will be described with reference to the accompanying drawings. Like reference characters refer to like elements throughout.

As used herein, the singular forms “a”, “an”, and “the” are intended to include the plural forms as well, unless the context clearly indicates otherwise. As used herein, the term “and/or” includes any and all combinations of one or more of the associated listed items and may be abbreviated as “/”.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

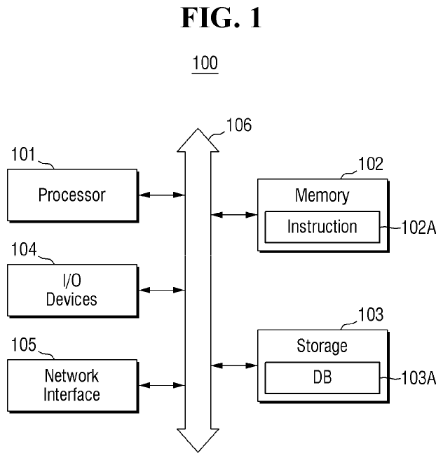

FIG. 1 is an exemplary view illustrating an integrated circuit design system using a computing system according to example embodiments.

Referring to FIG. 1, an integrated circuit design system 100 using a computing system may be a fixed computing system such as a desktop computer, a workstation and a server, or may be a portable computing system such as a laptop computer. Hereinafter, the integrated circuit design system 100 using a computing system will be referred to as a design system 100.

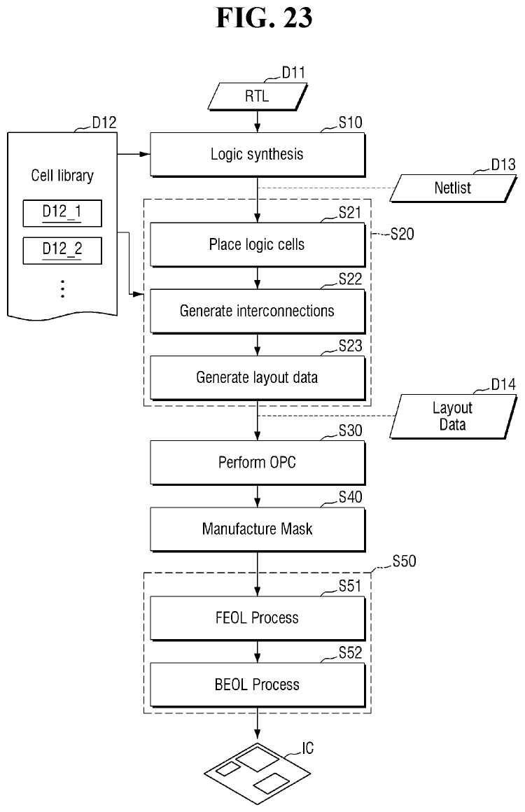

An integrated circuit (IC) according to some embodiments may be designed and fabricated using the design system 100. For example, a layout and a physical design of the integrated circuit may be generated using the design system 100, and then the integrated circuit may be fabricated based on the generated layout and physical design of the integrated circuit. A method for fabricating an integrated circuit based on a layout and a physical design of the integrated circuit will be described below with reference to FIG. 23.

The design system 100 may include a processor 101, a memory 102, a storage device 103, input/output devices 104, and a network interface 105. The processor 101, the memory 102, the storage device 103, the input/output devices 104, and the network interface 105 may be connected to a bus 106, and may perform communication with one another via the bus 106.

The processor 101 may be referred to as a processing unit, and may include at least one core capable of executing any instruction set (e.g., IA-32 (Intel Architecture-32), 64-bit extension IA-32, x86-64, PowerPC, Sparc, MIPS, ARM, IA-64, etc.) like a micro-processor, an application processor (AP), a digital signal processor (DSP) and a graphic processing unit (GPU). The processor 101 may access the memory 102 via the bus 106, and may execute an instruction 102A stored in the memory 102. When the instruction 102A is executed by the processor 101, the instruction 102A may allow the processor 101 to design a layout and a physical design of the integrated circuit. Instruction 102A may refer to a single instruction and/or a plurality of instructions.

The memory 102 may store the instruction 102A for fabricating the integrated circuit according to some embodiments or at least a portion of the instruction 102A. The instruction 102A may include a plurality of instruction languages capable of being executed by the processor 101. The instruction 102A may allow the processor 101 to perform at least a portion of steps included in a method for designing and fabricating an integrated circuit.

The storage device 103 may not lose stored data even though power supplied to the design system 100 is disconnected. For example, the storage device 103 may include a non-volatile integrated circuit, or may include a storage medium such as a magnetic tape, an optical disk, and/or a magnetic disk. In addition, the storage device 103 may be detachable from the design system 100.

The storage device 103 may store the instruction 102A, and may load the instruction 102A or at least a portion thereof from the storage device 103 into the memory 102 before the instruction 102A is executed by the processor 101. In another embodiment, the storage device 103 may store a file written in a program language, and may load the instruction 102A generated by a complier, etc. or at least a portion thereof from the file into the memory 102. In addition, the storage device 103 may store a database 103A, and the database 103A may include information required to design the integrated circuit, for example, a cell library.

The storage device 103 may store data to be processed by the processor 101 or data processed by the processor 101. For example, the processor 101 may generate new data by processing the data stored in the storage device 103 in accordance with the instruction 102A, and may store the newly generated data in the storage device 103. For example, the storage device 103 may store Register-Transfer Level (RTL) data, a netlist, and/or a layout.

The input/output devices 104 may include an input device such as a keyboard, a pointing device, etc., and may include an output device such as a display device, a printer, etc. For example, through the input/output devices 104, a user (e.g., a designer of a semiconductor integrated circuit) may trigger execution of the instruction 102A by the processor 101, input the RTL data and/or the netlist or identify the layout.

The network interface 105 may provide access to a network outside the design system 100. For example, the network may include multiple computing systems and communication links, and the communication links may include wired links, optical links, wireless links, and/or any other type links.

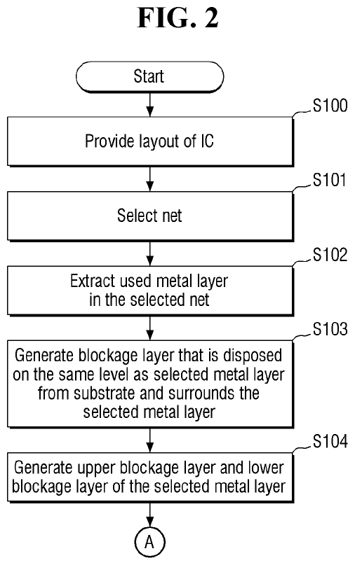

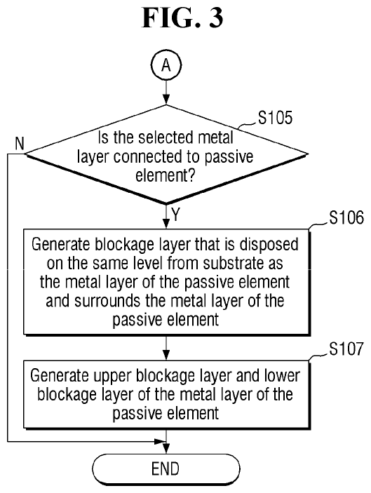

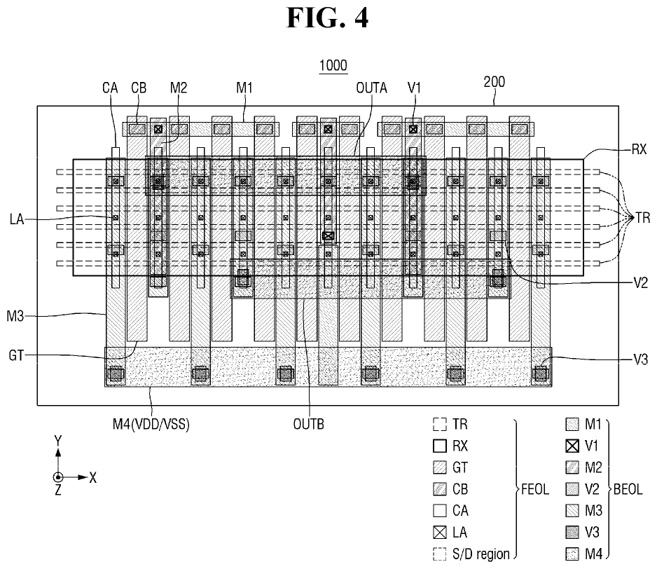

FIGS. 2 and 3 are exemplary flow charts illustrating a method for designing an integrated circuit by using the design system of FIG. 1. FIGS. 4 to 16 are exemplary views illustrating a method for designing an integrated circuit by using the design system of FIG. 1. Hereinafter, a method for designing an integrated circuit by using a computing system according to example embodiments will be described with reference to FIGS. 2 to 16. The method for designing an integrated circuit according to example embodiments, which will be described below, may be performed in the design system 100 of FIG. 1 as the instruction 102A is executed by the processor 101.

First, referring to FIGS. 2 and 4 together, a layout of an integrated circuit may be provided (S100).

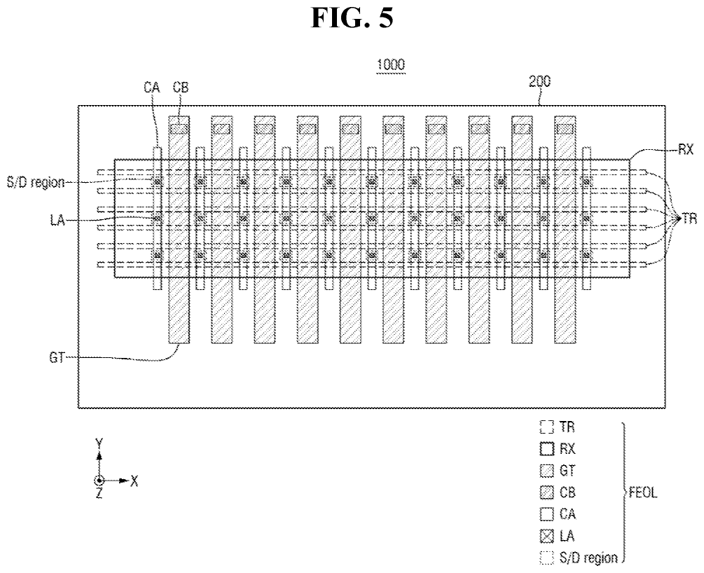

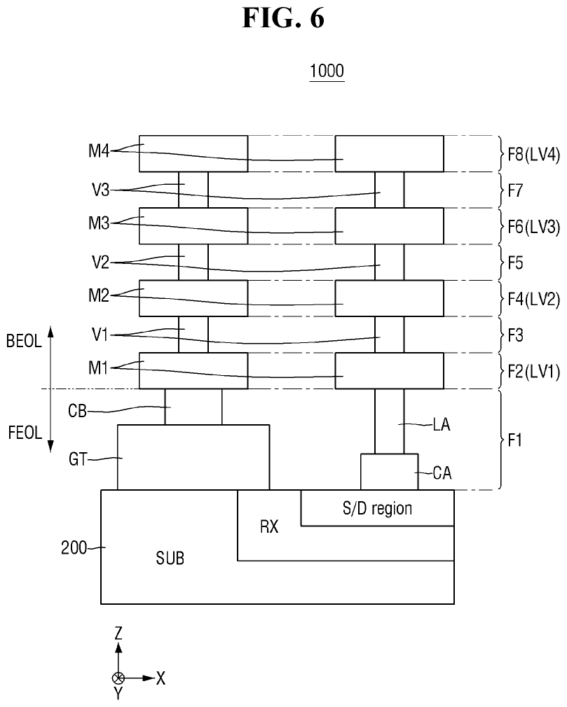

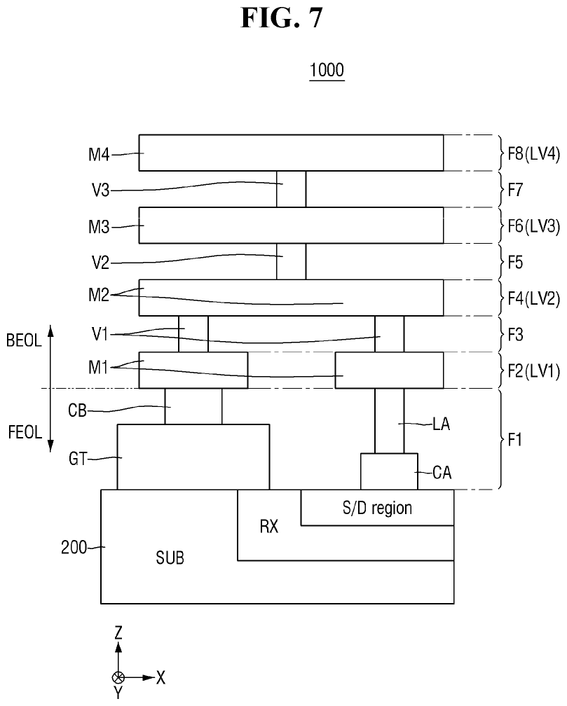

FIG. 4 is a view exemplarily illustrating a layout of an integrated circuit 1000 that is provided, and FIG. 5 is a view exemplarily illustrating a front end of line (FEOL) 210 of the integrated circuit of FIG. 4. FIGS. 6 and 7 are schematic views illustrating a stacked structure of the integrated circuit 1000 of FIG. 4. In FIGS. 6 and 7, for convenience of description, a transistor TR included in the integrated circuit 1000 is omitted and sizes of a gate electrode GT, a source/drain contact CA, a gate contact CB, a landing via LA, metal layers M1 to M4, and vias V1 to V3 are arbitrarily shown. FIGS. 6 and 7 may be different from the actual cross-sectional view of the integrated circuit 1000. Hereinafter, the integrated circuit 1000 according to example embodiments will be described with reference to FIGS. 4 to 7.

The integrated circuit 1000 may include a substrate 200, a Front End of Line (FEOL) and a Back End of Line (BEOL). The substrate 200 may be disposed on a plane defined by a first direction X and a second direction Y. The substrate 200 may be a silicon substrate or a silicon-on-insulator (SOI) substrate. Alternatively, the substrate 200 may include, but is not limited to, silicon germanium, silicon germanium on insulator (SGOI), indium antimonide, lead telluride, indium arsenide, indium phosphide, gallium arsenide or gallium antimonide. The substrate 200 may be implemented as a P-type substrate or an N-type substrate in accordance with embodiments, but is not limited thereto.

The FEOL may be formed in at least a portion of the substrate 200 and on the substrate 200. The FEOL may include an active region RX, a source/drain (S/D) region, a gate electrode GT, a gate via CB, source/drain contacts CA, and a landing via LA.

The active region RX may be formed inside the substrate 200. The active region RX may be part of the substrate 200 (e.g., formed by etching the substrate 200) or may be formed on the substrate 200 (e.g., an epitaxial layer grown from the substrate 100). In example embodiments, an upper surface of the active region RX may be coplanar with an upper surface of the substrate 200. The active region RX may be formed to be extended in the first direction X and the second direction Y. The active region RX may include a plurality of impurity regions (e.g., a P-type impurity region (p+) and/or an N-type impurity region (n+)), and the plurality of impurity regions may include the S/D region. At least one transistor TR may be defined by the impurity regions.

Each of the transistors TR may be disposed to be extended lengthwise in the first direction X. In some embodiments, the transistors TR may include, but are not limited to, a fin-type field effect transistor (FinFET), a tunneling field effect transistor (tunneling FET), a three-dimensional (3D) transistor or a vertical field effect transistor (Vertical FET), a planar transistor, two-dimensional (2D) material based field effect transistors (FETs) and a heterogeneous structure thereof, a bipolar junction transistor, a laterally diffused metal oxide semiconductor (LDMOS) transistor, a transistor including a nanowire or a nanosheet, or a Multi-Bridge Channel Field Effect Transistor (MBCFET™).

The gate electrode GT of the transistor TR may be disposed to be extended lengthwise in the second direction Y on the substrate, and the plurality of gate electrodes GT may be disposed to be spaced apart from each other in the first direction X. The gate via CB may be disposed to be extended in a third direction Z on the gate electrode GT. The gate via CB may contact the gate electrode GT. The gate via CB may connect the gate electrode GT to the BEOL.

The source/drain contacts CA may be disposed to be extended lengthwise in the second direction Y between the gate electrodes GT. The plurality of source/drain contacts CA may be disposed to be spaced apart from each other in the first direction X. In this way, the source/drain contacts CA may be extended lengthwise in the second direction Y to contact the plurality of S/D regions disposed between the gate electrodes GT. The landing via LA may be disposed to be extended in the third direction Z on the source/drain contact CA. The landing via LA may contact the source/drain contact CA. The landing via LA may connect the source/drain contact CA to the BEOL.

The BEOL may include a plurality of metal layers M1, M2, M3, and M4 and a plurality of vias V1, V2, and V3 connecting the plurality of metal layers M1, M2, M3 and M4. The plurality of metal layers M1, M2, M3, and M4 and the plurality of vias V1, V2, and V3 are metal lines for transferring an electrical signal to the transistor TR, and may include a conductive material such as metal, Cu, Ag, Au, Al, or W, but are not limited thereto. Although the integrated circuit 1000 is shown in FIGS. 4, 6 and 7 as including four metal layers M1, M2, M3, and M4, the number of metal layers included in the BEOL is not limited thereto. The number of metal layers included in the BEOL of the integrated circuit 1000 may be smaller or greater than four.

The plurality of metal layers M1, M2, M3, and M4 may be sequentially stacked in the third direction Z from the substrate 200. Hereinafter, a position at which each of the metal layers M1, M2, M3, and M4 is disposed in the third direction Z from the substrate 200 will be defined as a level. For example, the position at which the metal layer M1 is disposed may be a level LV1, the position at which the metal layer M2 is disposed may be a level LV2, the position at which the metal layer M3 is disposed may be a level LV3, and the position at which the metal layer M4 is disposed may be a level LV4. In addition, a position at which an arbitrary metal layer Mx is disposed may be a level LVx (x is an integer greater than or equal to 1).

A portion of the metal layer M1 may be disposed to be extended in the first direction X. The metal layer M1 extended in the first direction X may bind some of the plurality of gate electrodes GT into one and may be partially disconnected, but is not limited thereto. Another portion of the metal layer M1 may be disposed to be extended in the second direction Y on the active region RX so that it is to be connected to the landing via LA. A portion of the metal layer M1 may be connected to the gate electrode GT through the gate via CB, and another portion of the metal layer M1 may be connected to the source/drain contact CA through the landing via LA. For example, a lower surface of the metal layer M1 may contact upper surfaces of the gate vias CB and the landing vias LA.

The metal layer M2 may be disposed to be extended in the second direction Y. A portion of the metal layer M2 may be disposed to be extended in the second direction Y, and may be connected to the metal layer M1 connected to the gate via CB through the via V1. Another portion of the metal layer M2 may be connected to the metal layer M1 connected to the landing via LA through the via V1. For example, a lower surface of the metal layer M2 may contact upper surfaces of the vias V1.

The metal layer M3 may be disposed to be extended in the second direction Y, and may be connected to the metal layer M2 through the via V2. For example, a lower surface of the metal layer M3 may contact upper surfaces of the vias V2, and lower surfaces of the vias V2 may contact an upper surface of the metal layer M2. A portion of the metal layer M3 may be connected to the gate electrode GT, and another portion of the metal layer M3 may be connected to the source/drain contact CA.

The metal layer M4 may be disposed to be extended in the first direction X, and may be connected to the metal layer M3 through the via V3. For example, a lower surface of the metal layer M4 may contact upper surfaces of the vias V3, and lower surfaces of the vias V3 may contact an upper surface of the metal layer M3. A portion of the metal layer M4 may be connected to the gate electrode GT, and another portion of the metal layer M4 may be connected to the source/drain contact CA. The metal layer M4 may include a power rail for transferring any one of a power voltage VDD or a ground voltage VSS to the transistor TR.

Meanwhile, FIG. 4 illustrates an example of an integrated circuit, and a configuration and arrangement of the FEOL and the BEOL of the integrated circuit according to some embodiments may be varied depending on embodiments.

Referring to FIGS. 6 and 7, the gate electrode GT, the gate contact CB, the source/drain contact CA, and the landing via LA may be formed in a first layer F1. A sum of heights of the gate electrode GT and the gate contact CB may be equal to a sum of heights of the source/drain contact CA and the landing via LA. The active region RX and the S/D region of the substrate 200 and the first layer F1 on the substrate 200 may be formed by an FEOL process, and second to eighth layers F2 to F8 may be formed by a BEOL process. Moreover, a contact area may be reduced from the second layer F2 toward the eighth layer F8. The second layer F2 on which the metal layer M1 is disposed may correspond to the level LV1, the fourth layer F4 on which the metal layer M2 is disposed may correspond to the level LV2, the sixth layer F6 on which the metal layer M3 is disposed may correspond to the level LV3, and the eighth layer F8 on which the metal layer M4 is disposed may correspond to the level LV4. The vias V1 may be disposed in the third layer F3, the vias V2 may be disposed in the fifth layer F5, and the vias V3 may be disposed in the seventh layer F7.

As shown in FIG. 6, portions of the metal layers M1 to M4 for transmitting an electrical signal to the gate electrode GT may be disconnected from portions of the metal layers M1 to M4 for transmitting an electrical signal to the S/D region, but the embodiments are not limited thereto. For example, as shown in FIG. 7, the metal layers M2, M3, and M4 may be connected as one so that the electrical signal to be transferred to the gate electrode GT and the source/drain region S/D may be transmitted at once through the metal layer M4, the via V3, the metal layer M3, the via V2, and the metal layer M2.

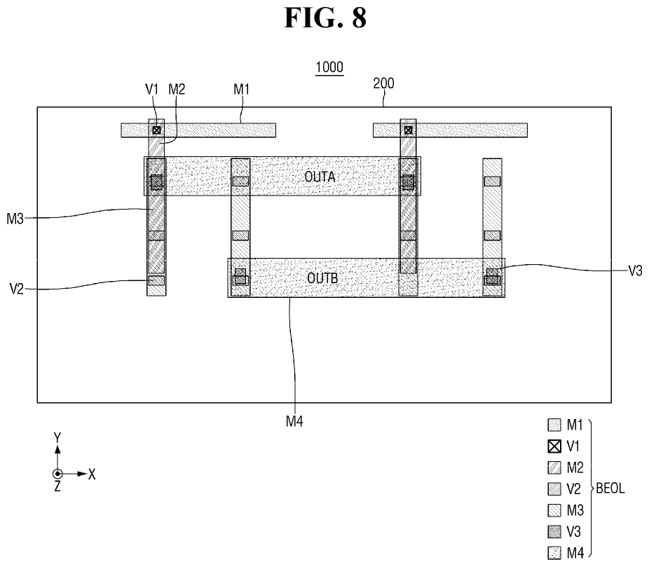

Referring back to FIG. 2, a net may be selected from a layout of the integrated circuit that is provided (S101). For example, in the layout of the provided integrated circuit, a net having an increased need to prevent performance degradation due to RC delay may be selected from the layout of the provided integrated circuit. For example, OUTA and OUTB, which are shown in FIG. 4, may be selected as the nets. Referring to FIGS. 2 and 8 together, a metal layer used for the selected net may be extracted (S102). The metal layer used for the selected net may include at least one of metal layers M1, M2, M3, and M4 constituting the BEOL included in the integrated circuit 1000. For example, when OUTA and OUTB are selected as the nets from the layout of the integrated circuit 1000, the metal layers M1, M2, M3, and M4 connected to OUTA and OUTB may be extracted from the net list.

In some embodiments, a schematic view of the integrated circuit may be provided first before the layout of the integrated circuit is provided. In this case, a specific net of input nets of the integrated circuit may be selected from the schematic view of the integrated circuit. Afterwards, the layout of the integrated circuit may be provided, and the metal used for the pre-selected specific net may be extracted.

Any metal layer Mx, which is included in the BEOL of the integrated circuit 1000 and is disposed at a specific level in the third direction Z from the substrate 200, may be selected via the steps S100, S101 and S102. For example, the metal layer Mx may be any one of the metal layers M1, M2, M3, and M4 shown in FIG. 8. Hereinafter, it is assumed that an arbitrary metal layer Mx disposed at the level LVx from the substrate 200 is selected, but the description of the metal layer Mx may be equally applied to all the metal layers M1, M2, M3, and M4 used in the selected net shown in FIG. 8.

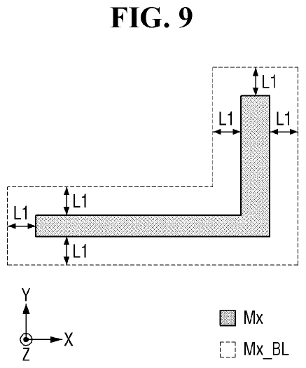

Referring back to FIG. 2, a blockage layer disposed at the same level from the substrate 200 with respect to the selected metal layer and surrounding the selected metal layer may be generated (S103). Referring to FIG. 9 together with FIG. 2, FIG. 9 is a view exemplarily illustrating a case that a blockage layer Mx_BL is generated at the same level as the metal layer Mx when there is no metal layer disposed to be adjacent to the same level. As shown in FIG. 9, when the metal layer Mx has a polygon shape, the blockage layer Mx_BL may be generated to surround the metal layer Mx while having a predetermined interval L1 from the metal layer Mx. For example, the blockage layer Mx_BL may have the same polygon shape as the metal layer Mx.

The interval L1 between the metal layer Mx and the blockage layer Mx_BL may be constantly formed in accordance with a default value based on a type of the metal layer Mx. The interval L1 between the metal layer Mx and the blockage layer Mx_BL may be determined by a metal max space design rule in accordance with the type of the metal layer Mx. The metal max space design rule is determined by a maximum interval between metal patterns (e.g., metal layers and/or dummy patterns) included in the BEOL when the integrated circuit is designed.

For example, when a dummy pattern to which an electrical signal is not actually routed is generated near the metal layer Mx to which an electrical signal is actually routed, since both the metal layer Mx and the dummy pattern include a metal, the dummy pattern should be able to be generated near the metal layer Mx in consideration of the metal max space design rule. At this time, the maximum interval between the metal layer Mx and the dummy pattern may be determined depending on the type of the metal layer Mx by the design rule.

The interval L1 between the metal layer Mx and the blockage layer Mx_BL may correspond to half of the metal max space of the corresponding metal layer Mx. For example, when the metal layer Mx is a metal layer disposed at a relatively low level from the substrate 200, the interval L1 between the metal layer Mx and the blockage layer Mx_BL may be, for example, 0.2 μm. Alternatively, when the metal layer Mx is a metal layer disposed at a relatively high level from the substrate 200, the interval L1 between the metal layer Mx and the blockage layer Mx_BL may be, for example, 0.6 μm. However, the interval L1 between the metal layer Mx and the blockage layer Mx_BL is not limited to the numerical values.

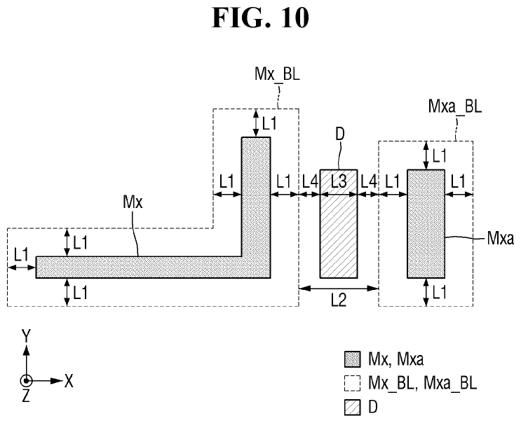

Referring to FIG. 10, unlike FIG. 9, when there is a metal layer Mxa disposed to be adjacent at the same level as the metal layer Mx from the substrate 200, blockage layers Mx_BL and Mxa_BL may be generated with respect to the metal layers Mx and Mxa, respectively. In this case, the blockage layer Mxa_BL for the metal layer Mxa may be also generated to surround the metal layer Mxa at the same level LVx as the metal layer Mxa while having have a predetermined interval L1 from the metal layer Mxa in accordance with the metal max space design rule.

In addition, the blockage layers Mx_BL and Mxa_BL, which are generated to be adjacent to each other, may be generated with a minimum interval L2 for inserting a dummy pattern D later generated between the blockage layers Mx_BL and Mxa_BL. For example, the minimum interval L2 for inserting the dummy pattern D between the blockage layers Mx_BL and Mxa_BL may be a sum of a minimum width L3 of the dummy pattern D and minimum intervals L4 from the dummy pattern D to each of the blockage layers Mx_BL and Mxa_BL. For example, when the minimum width L3 of the dummy pattern D is 0.08 μm and the minimum interval L4 from the dummy pattern D to each of the blockage layers Mx_BL and Mxa_BL is 0.22 μm, the interval L2 between the blockage layers Mx_BL and Mxa_BL may be 0.52 μm, but is not limited thereto.

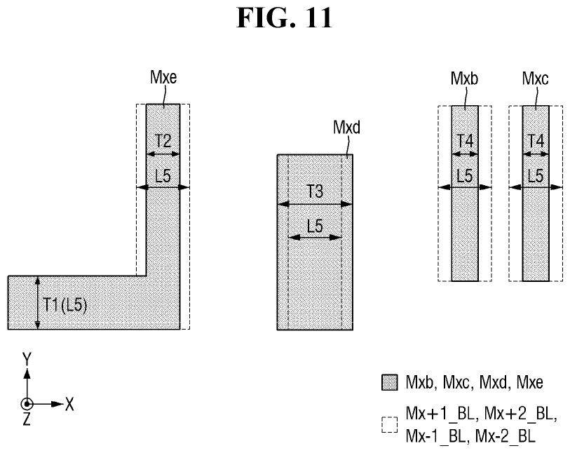

Referring back to FIG. 2, an upper blockages layer and a lower blockage layer may be generated with respect to the selected metal layer (S104). Hereinafter, a method of generating upper blockage layers Mx+1_BL and Mx+2_BL and lower blockage layers Mx−1_BL and Mx−2_BL with respect to metal layers Mxb, Mxc, Mxd, and Mxe will be described with reference to FIGS. 11 to 13.

First, referring to FIG. 11, all of the metal layers Mxb, Mxc, Mxd, and Mxe may be metal layers disposed at the same level from the substrate 200. For example, the metal layers Mxb, Mxc, Mxd, and Mxe may be all disposed at the level LVx from the substrate 200. Widths of the metal layers Mxb, Mxc, Mxd, and Mxe disposed at the same level may be different from one another. For example, the width of the metal layer Mxb and the metal layer Mxc in the first direction X may be T4, and the width of the metal layer Mxd in the first direction X may be T3, which is greater than T4. The metal layer Mxe may be in the form of a polygon in which an element extended lengthwise in the first direction X and an element extended lengthwise in the second direction Y are combined with each other. A width of an element of the metal layer Mxe in the second direction Y, which is extended lengthwise in the first direction X, may be T1, and a width of an element of the metal layer Mxe in the first direction X, which is extended lengthwise in the second direction Y, may be T2 that is smaller than T1.

Hereinafter, a case that the upper blockage layers Mx+1_BL and Mx+2_BL and the lower blockage layers Mx−1_BL and Mx−2_BL are generated in the metal layer Mxb will be described as an example, but the upper blockage layers Mx+1_BL and Mx+2_BL and the lower blockage layers Mx−1_BL and Mx−2_BL may be generated in the same manner with respect to other metal layers Mxc, Mxd, and Mxe disposed at the same level as the metal layer Mxb.

The upper blockage layer Mx+1_BL may be generated at a level LVx+1, which is as much as one level higher than the level LVx from the substrate 200 with respect to the metal layer Mxb disposed at the level LVx from the substrate 200. In addition, the upper blockage layer Mx+2_BL may be generated at a level LVx+2, which is as much as two levels higher than the level LVx from the substrate 200 with respect to the metal layer Mxb.

Likewise, the lower blockage layer Mx−1_BL may be generated at a level LVx−1, which is as much as one level lower than the level LVx from the substrate 200 with respect to the metal layer Mxb. In addition, the lower blockage layer Mx−2_BL may be generated at a level LVx−2, which is as much as two levels lower than the level LVx from the substrate 200 with respect to the metal layer Mxb.

In this way, the lower blockage layer Mx−2_BL, the lower blockage layer Mx−1_BL, the upper blockage layer Mx+1_BL and the upper blockage layer Mx+2_BL of the metal layer Mxb may be respectively disposed at different levels in the third direction Z from the substrate 200.

FIG. 11 illustrates that two upper blockage layers Mx+1_BL and Mx+2_BL are generated at an upper level of the metal layers Mxb, Mxc, Mxd, and Mxe and two lower blockage layers Mx−1_BL and Mx−2_BL are generated at a lower level of the metal layers Mxb, Mxc, Mxd, and Mxe, but the embodiments are not limited thereto. For example, in some embodiments, one upper blockage layer or three or more upper blockage layers may be generated at a high level of the metal layers Mxb, Mxc, Mxd and Mxe. Alternatively or additionally, one lower blockage layer or three or more low blockage layers may be generated at a lower level of the metal layers Mxb, Mxc, Mxd and Mxe.

For example, when the metal layers Mxb, Mxc, Mxd, and Mxe are disposed at a relatively low level from the substrate 200, a sufficient space for generating a dummy pattern may not be formed at a level LVx−2, which is as much as two levels lower than the level LVx, at which the metal layers Mxb, Mxc, Mxd and Mxe are disposed. In this case, the lower blockage layer of the metal layers Mxb, Mxc, Mxd, and Mxe may be generated only at a level LVx−1, which is as much as one level lower than the level LVx, at which the metal layers Mxb, Mxc, Mxd, and Mxe are disposed.

The upper blockage layers Mx+1_BL and Mx+2_BL and the lower blockage layers Mx−1_BL and Mx−2_BL may be generated along a shape of each of the metal layers Mxb, Mxc, Mxd, and Mxe. In this case, a width L5 of the upper blockage layers Mx+1_BL and Mx+2_BL and the lower blockage layers Mx−1_BL and Mx−2_BL may be determined in accordance with the metal max space design rule. For example, as shown in FIG. 11, when the respective widths T4, T4, T3, and T2 of the metal layers Mxb, Mxc, Mxd, and Mxe are different from one another, the width L5 of the upper blockage layers Mx+1_BL and Mx+2_BL and the width L5 of the lower blockage layers Mx−1_BL and Mx−2_BL may be generated with a maximum width that is a space remaining after subtracting a minimum space for generating the dummy pattern.

Hereinafter, a case that the upper blockage layers Mx+1_BL for the metal layers Mxb, Mxc, Mxd, and Mxe are generated at the level LVx+1 from the substrate 200 will be described as an example. This description may be equally applied to a case that the upper blockage layers Mx+2_BL for the metal layers Mxb, Mxc, Mxd, and Mxe are generated at the level LVx+2 from the substrate 200, a case that the lower blockage layers Mx−1_BL for the metal layers Mxb, Mxc, Mxd and Mxe are generated at the level LVx−1 from the substrate 200, and a case that the lower blockage layers Mx−2_BL for the metal layers Mxb, Mxc, Mxd, and Mxe are generated at the level LVx−2 from the substrate 200.

First, referring to FIG. 11, the upper blockage layers Mx+1_BL may be respectively generated for the metal layers Mxb, Mxc, Mxd, and Mxe disposed at the level LVx from the substrate 200. The upper blockage layers Mx+1_BL may be disposed at the level LVx+1 from the substrate 200, and may have a predetermined width L5.

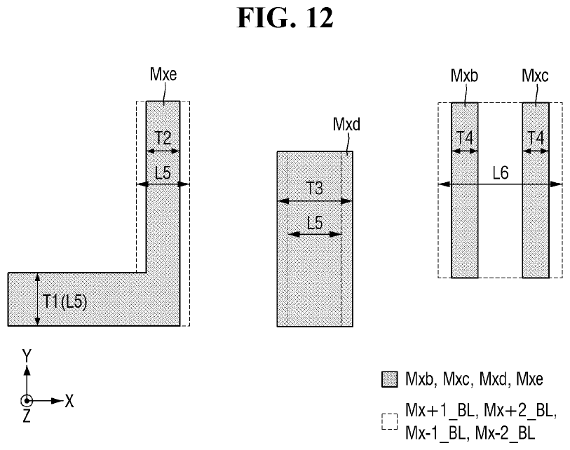

Next, referring to FIG. 12, resizing may be performed for the upper blockage layers Mx+1_BL of each of the metal layers Mxb, Mxc, Mxd, and Mxe. Resizing refers to an operation of increasing and decreasing the width of each of the upper blockage layers Mx+1_BL of the metal layers Mxb, Mxc, Mxd, and Mxe as much as a predetermined interval. In this case, referring to FIG. 11, since there is a sufficient interval between the upper blockage layer Mx+1_BL of the metal layer Mxd and the upper blockage layer Mx+1_BL of the metal layer Mxe, the upper blockage layer Mx+1_BL of the metal layer Mxd and the upper blockage layer Mx+1_BL of the metal layer Mxe may not be merged with each other even though the width of the upper blockage layer Mx+1_BL of the metal layer Mxd and the upper blockage layer Mx+1_BL of the metal layer Mxe is increased as much as a predetermined interval from the existing width W5 during resizing.

However, since the upper blockage layer Mx+1_BL of the metal layer Mxb and the upper blockage layer Mx+1_BL of the metal layer Mxc are relatively close to each other, when the width of the upper blockage layer Mx+1_BL of the metal layer Mxb and the upper blockage layer Mx+1_BL of the metal layer Mxc is increased as much as a predetermined interval from the existing width L5 during resizing, the upper blockage layer Mx+1_BL of the metal layer Mxb and the upper blockage layer Mx+1_BL of the metal layer Mxc may be merged with each other to have a width L6 as shown in FIG. 12.

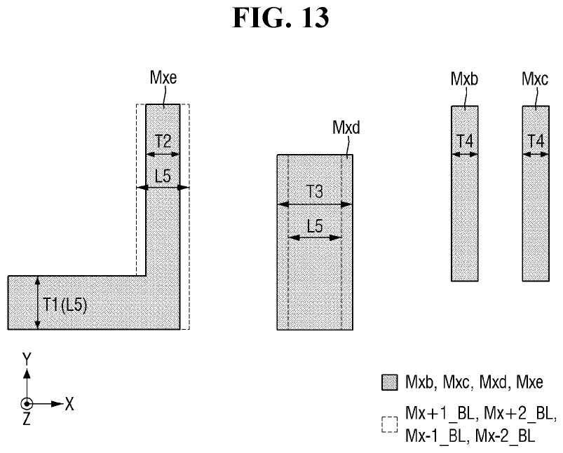

In this case, since there is not sufficient space for inserting the dummy pattern between the upper blockage layer Mx+1_BL of the metal layer Mxb and the upper blockage layer Mx+1_BL of the metal layer Mxc, the upper blockage layer Mx+1_BL of the metal layer Mxb and the upper blockage layer Mx+1_BL of the metal layer Mxc may be removed as shown in FIG. 13.

Next, referring to FIG. 3, it is determined whether the selected metal layer is connected to a passive element (S105). When the selected metal layer is not connected to the passive element (S105-N), the step may be terminated. When the selected metal layer is connected to the passive element (S105-Y), a blockage layer for the metal layer included in the passive element may be generated (S106).

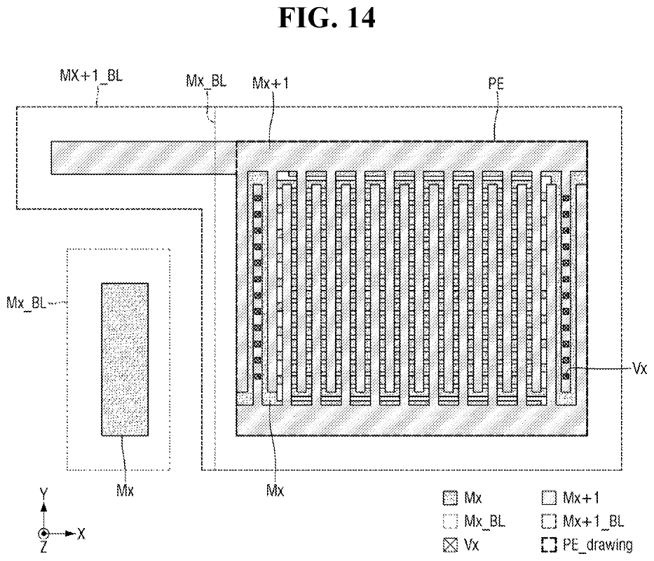

Referring to FIG. 14, a portion of the metal layer Mx extracted in step S102 of FIG. 2 may be connected to a passive element PE. The passive element PE may be, for example, a vertical native capacitor (VNCAP), and may include a metal layer Mx disposed at the level LVx and a metal layer Mx+1 disposed at the level LVx+1, which is as much as one level higher than the level LVx. The metal layer Mx and the metal layer Mx+1 of the passive element PE may be connected to each other through the via VX.

The blockage layer Mx_BL disposed at the same level LVx as the metal layer Mx from the substrate 200, surrounding the metal layer Mx may be generated with respect to the metal layer Mx. Likewise, the metal layer Mx+1_BL disposed at the same level as the metal layer Mx+1 from the substrate 200, surrounding the metal layer Mx+1 may be generated for the metal layer Mx+1.

Although the VNCAP is described in FIG. 14 as an example, the type of the passive element PE is not limited thereto. For example, the passive element PE according to some embodiments may include a metal layer Mx and a metal layer Mx+1, and may include an inductor, a resistor, a capacitor, and the like, which are formed in the BEOL of the integrated circuit 1000.

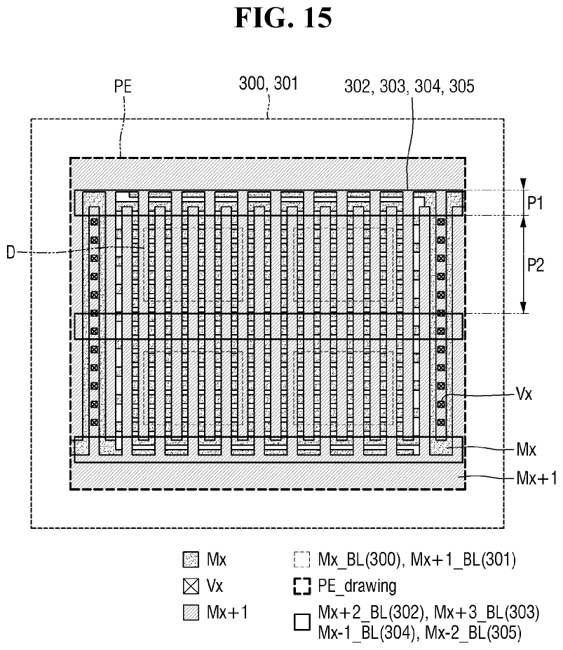

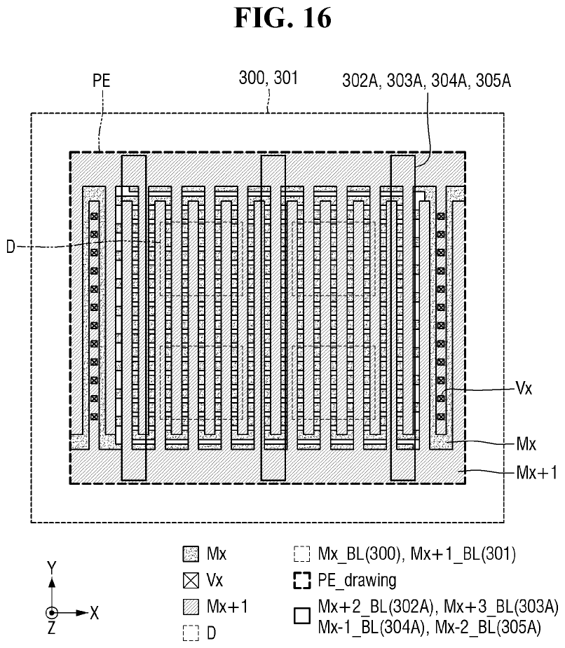

Referring back to FIG. 3, an upper blockage layer and a lower blockage layer may be generated with respect to the metal layer included in the passive element (S107). Hereinafter, a method of generating upper blockage layers Mx+2_BL and Mx+3_BL and lower blockage layers Mx−1_BL and Mx−2_BL with respect to a metal layer Mx and a metal layer Mx+1, which are included in a passive element PE, will be described with reference to FIGS. 15 and 16. Also, in the following description, it is assumed that the metal layer Mx is disposed at the level LVx from the substrate 200 and the metal layer Mx+1 is disposed at the level LVx+1, which is as much as one level higher than the level LVx from the substrate 200.

First, referring to FIG. 15, the upper blockage layer Mx+2_BL may be disposed at the level LVx+2, which is as much as one level higher than the level LVx+1 from the substrate 200 with respect to the metal layer Mx+1 and which is disposed at a higher level than the metal layers Mx and Mx+1 included in the passive element PE. Also, the upper blockage layer Mx+3_BL may be disposed at the level LVx+3, which is as much as two levels higher than the level LVx+1 from the substrate 200.

In addition, the lower blockage layer Mx−1_BL may be disposed at the level LVx−1, which is as much as one level lower than the level LVx from the substrate 200 with respect to the metal layer Mx disposed at a lower level in the metal layers Mx and Mx+1 included in the passive element PE. Also, the lower blockage layer Mx−2_BL may be disposed at the level LVx−2, which is as much as two levels lower than the level LVx from the substrate 200.

In FIG. 15, the passive element PE is shown as including two metal layers Mx and Mx+1, but the embodiments are not limited thereto. For example, in some embodiments, the passive element PE may include three or more metal layers disposed at different levels from the substrate 200. In this case, the upper blockage layers may be generated with respect to the metal layer disposed at the highest level among the metal layers included in the passive element PE, and the lower blockage layers may be generated with respect to the metal layer disposed at the lowest level among the metal layers included in the passive element PE.

In FIG. 15, two upper blockage layers Mx+2_BL and Mx+3_BL are shown as being generated at the upper level of the metal layer Mx+1 and two lower blockage layers Mx−1_BL and Mx−2_BL are shown as being generated at the lower level of the metal layer Mx, but the embodiments are not limited thereto. For example, in some embodiments, one upper blockage layer or three or more upper blockage layers may be generated at the upper level of the metal layer Mx, and one lower blockage layer or three or more lower blockage layers may be generated at the lower level of the metal layer Mx. For example, when the metal layer Mx is disposed at a relatively low level from the substrate 200, a sufficient space for generating a dummy pattern may not be formed at the level LVx−2, which is as much as two levels lower than the level LVx, at which the metal layer Mx is disposed. In this case, the lower blockage layer of the metal layer Mx may be generated only at the level LVx−1, which is as much as one level lower than the level LVx, at which the metal layer Mx is disposed.

As shown in FIG. 15, the upper blockage layers Mx+2_BL and Mx+3_BL and the lower blockage layers Mx−1_BL and Mx−2_BL may be disposed to be extended lengthwise in the first direction X, and the upper and lower blockage layers Mx−2_BL, Mx−1_BL, Mx+2_BL, and Mx+3_BL disposed at the same level may be disposed to be spaced apart from one another in the second direction Y. In addition, the upper blockage layers Mx+2_BL and Mx+3_BL and the lower blockage layers Mx−1_BL and Mx−2_BL may be disposed to overlap the passive element PE in a plan view. At this time, each width P1 of the upper blockage layers Mx+2_BL and Mx+3_BL and the lower blockage layers Mx−1_BL and Mx−2_BL and an interval P2 of each of the upper and lower blockage layers Mx−2_BL, Mx−1_BL, Mx+2_BL, and Mx+3_BL in the second direction Y may be determined in accordance with the metal max space design rule.

Also, the dummy patterns D may be inserted between the upper and lower blockage layers Mx−2_BL, Mx−1_BL, Mx+2_BL, and Mx+3_BL, which are disposed at the same level, at the respective levels LVx−2, LVx−1, LVx+2, and LVx+3 at which the upper and lower blockage layers Mx−2_BL, Mx−1_BL, Mx+2_BL, and Mx+3_BL are disposed.

However, the shapes of the upper blockage layers Mx+2_BL and Mx+3_BL and the lower blockage layers Mx−2_BL and Mx−1_BL of the passive element PE is not limited to those shown in FIG. 15. For example, referring to FIG. 16, the upper blockage layers Mx+2_BL and Mx+3_BL and the lower blockage layers Mx−2_BL and Mx−1_BL of the passive element PE may be disposed to be extended lengthwise in the second direction Y, and the upper and lower blockage layers Mx−2_BL, Mx−1_BL, Mx+2_BL, and Mx+3_BL, which are disposed at the same level, may be disposed to be spaced apart from one another in the first direction X. In addition, the dummy patterns D may be inserted between the upper and lower blockage layers Mx−2_BL, Mx−1_BL, Mx+2_BL, and Mx+3_BL, which are disposed at the same level, at the respective levels LVx−2, LVx−1, LVx+2, and LVx+3 at which the upper and lower blockage layers Mx−2_BL, Mx−1_BL, Mx+2_BL, and Mx+3_BL are disposed.

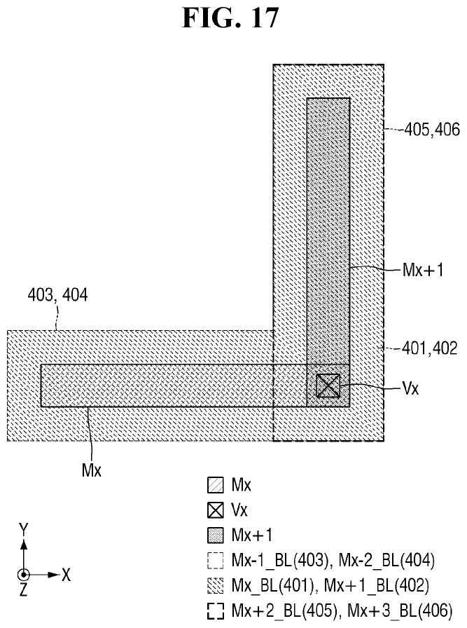

FIGS. 17 to 19 are exemplary views illustrating a method of designing an integrated circuit by using the system of FIG. 1.

FIG. 17 is a view exemplarily illustrating metal layers Mx and Mx+1 used in the net selected in the step S102 of FIG. 2. Referring to FIG. 17, the metal layer Mx may be disposed at the level LVx from the substrate 200, and the metal layer Mx+1 may be disposed at the level Lx+1 from the substrate 200. For example, the metal layer Mx+1 may be disposed at a level higher than that of the metal layer Mx as much as one level from the substrate 200. The metal layer Mx may be disposed to be extended lengthwise in the first direction X, and the metal layer Mx+1 may be disposed to be extended lengthwise in the second direction Y. The metal layer Mx and the metal layer Mx+1 may be connected to each other through the via Vx extended in the third direction Z. The metal layers Mx and Mx+1 may be routed to transfer an electrical signal to the transistor TR formed in the FEOL of the integrated circuit 1000, and may include a conductive material.

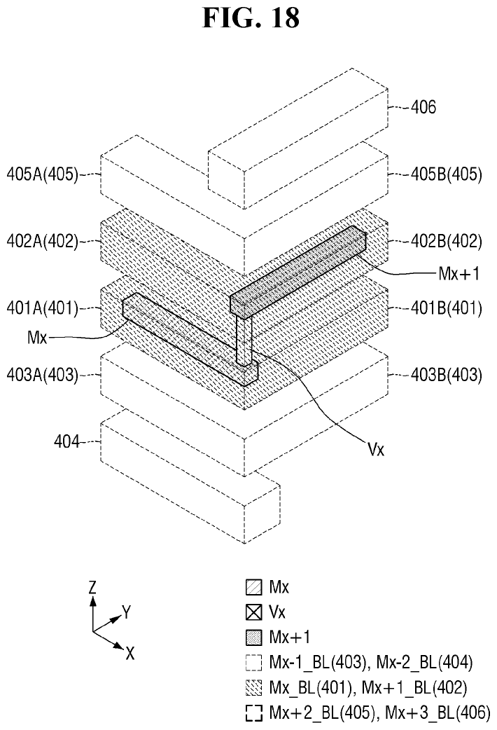

Next, referring to FIG. 18, a blockage layer 401A disposed at the same level LVx as the metal layer Mx from the substrate 200, surrounding the metal layer Mx may be generated with respect to the metal layer Mx. Also, with respect to the metal layer Mx, an upper blockage layer 402A may be generated at the level LVx+1, which is as much as one level higher than the level LVx from the substrate 200, and an upper blockage layer 405A may be generated at the level LVx+2, which is as much as two levels higher than the level LVx. In addition, with respect to the metal layer Mx, a lower blockage layer 403A may be generated at the level LVx−1 lower than the level LVx as much as one level from the substrate 200, and a lower blockage layer 404 may be generated at the level LVx−2, which is as much as two levels lower than the level LVx.

Likewise, a blockage layer 402B disposed at the same level LVx+1 as the metal layer Mx+1 from the substrate 200, surrounding the metal layer Mx+1 may be generated with respect to the metal layer Mx+1. Also, with respect to the metal layer Mx+1, an upper blockage layer 405B may be generated at the level LVx+2, which is as much as one level higher than the level LVx+1 from the substrate 200, and an upper blockage layer 406 may be generated at the level LVx+3, which is as much as two levels higher than the level LVx+1. In addition, with respect to the metal layer Mx+1, a lower blockage layer 401B may be generated at the level LVx, which is as much as one level lower than the level LVx+1 from the substrate 200, and a lower blockage layer 403B may be generated at the level LVx−1, which is as much as two levels lower than the level LVx+1.

In this case, the blockage layers disposed at the same level may be integrally generated. For example, the blockage layer 401A of the metal layer Mx disposed at the level LVx and the lower blockage layer 401B of the metal layer Mx+1 disposed at the same level LVx may be generated as an integral body Mx_BL 401. In addition, the upper blockage layer 402A of the metal layer Mx disposed at the level LVx+1 and the blockage layer 402B of the metal layer Mx+1 disposed at the same level LVx+1 may be generated as an integral body Mx+1_BL 402.

Likewise, the upper blockage layer 405A of the metal layer Mx disposed at the level LVx+2 and the upper blockage layer 405B of the metal layer Mx+1 disposed at the same level LVx+2 may be generated as an integral body Mx+2_BL 405.

Also, the lower blockage layer 403A of the metal layer Mx disposed at the level LVx−1 and the lower blockage layer 403B of the metal layer Mx+1 disposed at the same level LVx−1 may be generated as an integral body Mx−1_BL 403.

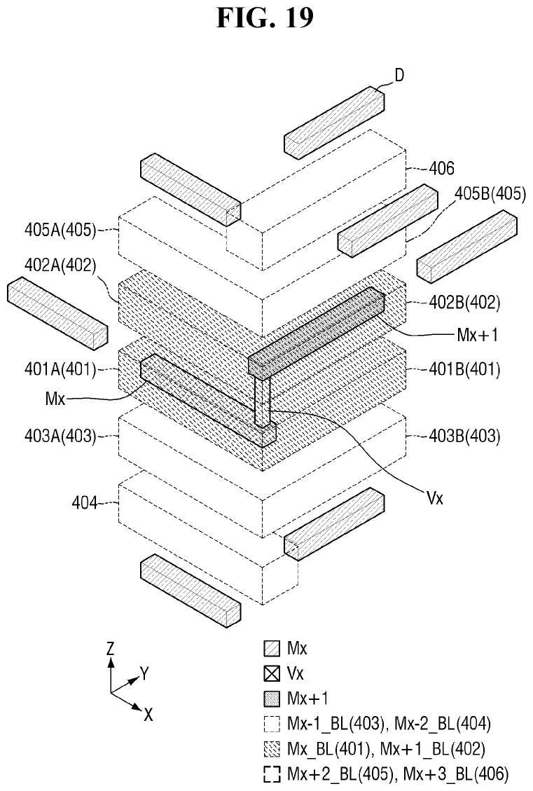

Next, referring to FIG. 19, the dummy patterns D may be generated near the metal layers Mx and Mx+1. In this case, the dummy patterns D may be generated outside a space, in which the blockage layers 401, 402, 403, 404, 405, and 406 are generated, near the metal layers Mx and Mx+1. For example, as shown in FIG. 19, the dummy patterns D may be generated in a space, in which the blockage layers 401, 402, 403, 404, 405, and 406 are not generated, near the metal layers Mx and Mx+1 in the BEOL.

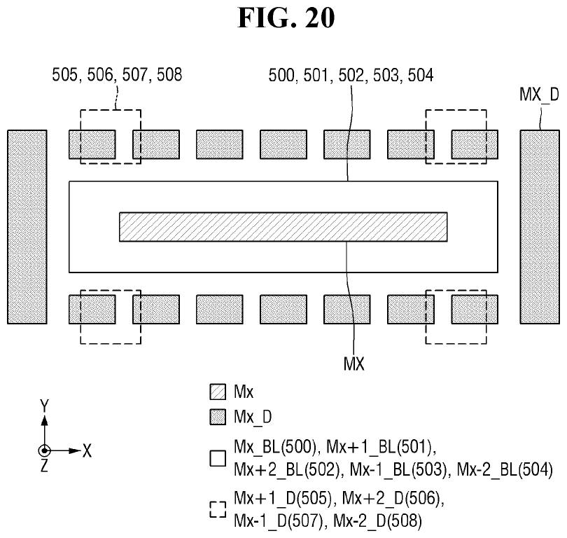

FIGS. 20 to 22 are exemplary views illustrating an effect of an integrated circuit fabricated in accordance with example embodiments.

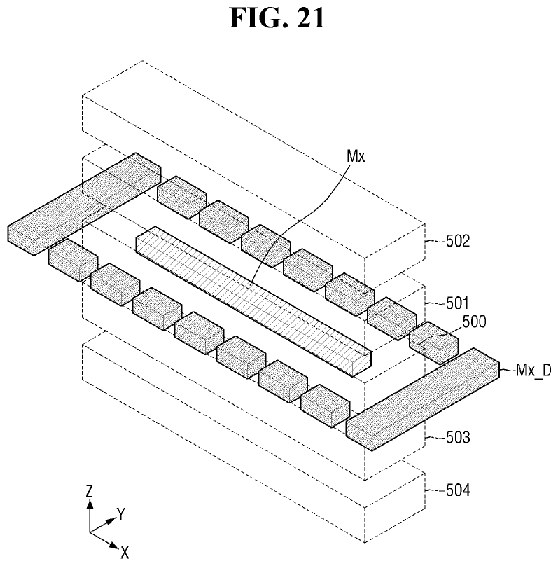

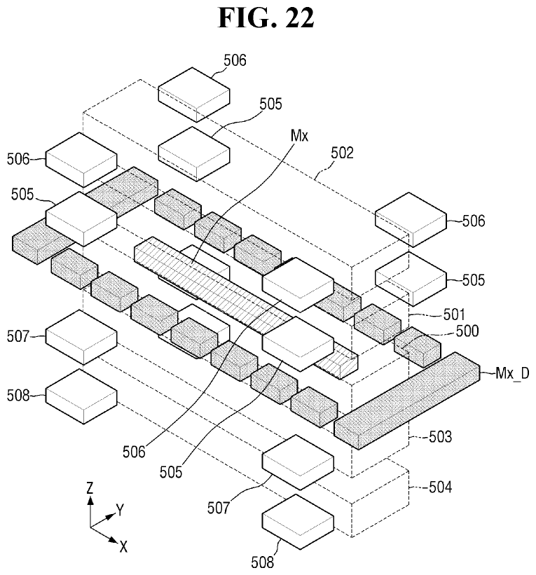

FIG. 20 is a top view illustrating that a metal layer Mx, dummy patterns Mx_D, Mx+1_D, Mx+2_D, Mx−1_D, and Mx−2_D and blockage layers Mx_BL, Mx+1_BL, Mx+2_BL, Mx−1_BL, and Mx−2_BL are viewed from the top. FIG. 21 is an exemplary view illustrating that a metal layer Mx, dummy patterns Mx_D and blockage layers Mx_BL, Mx+1_BL, Mx+2_BL, Mx−1_BL, and Mx−2_BL are viewed from the side. FIG. 22 is an exemplary view illustrating that dummy patterns Mx+1_D, Mx+2_D, Mx−1_D, and Mx−2_D are added.

First, referring to FIGS. 20 and 21, the blockage layer Mx_BL surrounding the metal layer Mx may be formed at the same level as the metal layer Mx, the upper blockage layers Mx+1_BL and Mx+2_BL of the metal layer Mx may be generated at a level higher than the metal layer Mx, and the lower blockage layers Mx−1_BL and Mx−2_BL of the metal layer Mx may be generated at a level lower than the metal layer Mx. Two upper blockage layers and two lower blockage layers of the metal layer Mx are shown in FIG. 20 but the number of each of upper blockage layers and lower blockage layers of the metal layer Mx may be varied depending on the embodiments.

The dummy patterns Mx_D disposed at the same level as the metal layer Mx may be generated outside a region, in which the blockage layer Mx_BL is not generated, that is, outside the blockage layer Mx_BL near the metal layer Mx.

Next, referring to FIGS. 20 and 22, the dummy patterns Mx+1_D, Mx+2_D, Mx−1_D, and Mx−2_D disposed at an upper level and a lower level of the metal layer Mx may be generated outside a region, in which the upper blockage layers Mx+1_BL and Mx+2_BL and the lower blockage layers Mx−1_BL and Mx−2_BL of the metal layer Mx are not generated, that is, outside the upper and lower blockage layers Mx+1_BL, Mx+2_BL, Mx−1_BL, and Mx−2_BL near the metal layer Mx. Therefore, as shown in FIG. 20, the dummy patterns Mx+1_D, Mx+2_D, Mx−1_D, and Mx−2_D disposed at the upper level and the lower level of the metal layer Mx may not overlap the metal layer Mx in a plan view.

The dummy patterns Mx_D disposed at the same level as the metal layer Mx and the dummy patterns Mx+1_D, Mx+2_D, Mx−1_D, and Mx−2_D disposed at a different level from the metal layer Mx may include a conductive material such as metal.

The dummy patterns Mx_D, Mx+1_D, Mx+2_D, Mx−1_D, and Mx−2_D are not metal patterns for actually routing an electric signal, unlike the metal layer Mx, but may fill an empty space between the metal layers in order to prevent unwanted dishing from occurring in the metal layer of the BEOL when a Chemical Mechanical Polishing (CMP) process of a semiconductor fabricating process is later performed. In this case, when the metal layer and the dummy pattern are close to each other, parasitic capacitance may be increased between the metal layer and the dummy pattern. Therefore, RC delay of the integrated circuit may be intensified, and performance of the metal layer may be degraded. To solve this problem, the metal layer and the dummy pattern should be spaced apart from each other at a predetermined interval.

In this case, the blockage layer Mx_BL, the upper blockage layers Mx+1_BL and Mx+2_BL and the lower blockage layers Mx−1_BL and Mx−2_BL, which are generated near the metal layer Mx, may prevent parasitic capacitance from being increased as the dummy patterns Mx_D, Mx+1_D, Mx+2_D, Mx−1_D, and Mx−2_D are disposed to be too close to the metal layer Mx.

FIG. 23 is an exemplary flow chart illustrating a method for fabricating an integrated circuit in accordance with example embodiments.

Referring to FIG. 23, a cell library D12 may include information on logic cells that include transistors TR of FIG. 4. For example, the cell library D12 may include function information, characteristic information, layout information, etc. of the logic cells. The cell library D12 may include data D12_1, D12-2, etc. that define the layout of the logic cells. The logic cells may include standard cells. The standard cells may have a structure conforming to a predetermined standard.

In step S10, a logic synthesis operation of generating netlist data D13 from RTL data D11 may be performed. For example, a semiconductor design tool such as Electronic Design Automation (EDA) may generate the netlist data D13, which includes bitstream or netlist, by performing logic synthesis from the RTL data D11, which is written in a hardware description language (HDL), with reference to the cell library D12. The HDL may include VHSIC Hardware Description Language (VHDL), Verilog, and the like. The cell library D12 may include information such as a height of the logic cell, the number of pins included in the logic cell and the number of tracks corresponding to the logic cell. In the logic synthesis process, the logic cells may be included in the integrated circuit (IC) by referring to the information of the cell library D12.

In step S20, a Place & Routing (P&R) operation of generating layout data D14 from the netlist data D13 may be performed. The place & routing step S20 may include a plurality of steps S21, S22 and S23.

In step S21, an operation of placing the logic cells may be performed. For example, the semiconductor design tool (e.g., P&R tool) may place a plurality of logic cells with reference to the cell library D12 from the netlist data D13.

In step S21, an operation of placing power rails may be performed. For example, an operation of placing a power rail included in the metal layer M4 of FIG. 4, transferring any one of a driving voltage VDD or a ground voltage VSS to a transistor may be performed.

In step S22, an operation of generating interconnections may be performed. Through the interconnection operation, an output pin and an input pin of the logic cell may be electrically connected to each other. The logic cell may include at least one via.

In step S23, an operation of generating the layout data D14 may be performed. The layout data D14 may include geometric information of cells and interconnections. The layout data D14 may have a format such as GDSII. For example, the layout data D14 may correspond to the layout drawing of the integrated circuit 1000 shown in FIG. 4.

In step S30, optical proximity correction (OPC) may be performed for the layout data D14 so that patterns on a mask may be determined. For example, a distortion phenomenon such as refraction due to characteristics of light may be corrected so that patterns of a desired shape may be formed in the layout data D14. In some embodiments, the layout of the integrated circuit may be limitedly modified in step S30. Therefore, the structure of the integrated circuit may be optimized. The step S30 may be referred to as design polishing.

In step S40, an operation of manufacturing a mask may be performed. At least one mask may be manufactured to form the patterns determined in step S30. The mask may include a photomask.

The blockage layers, the upper blockage layers, and the lower blockage layers according to example embodiments may be included in the layout data D14. For example, the blockage layers, the upper blockage layers and the lower blockage layers may be displayed in layout data in the form of a GDS file in which information on the layer of the integrated circuit (IC) is compressed. However, the blockage layers, the upper blockage layers, and the lower blockage layers exist in order to appropriately widen the interval between the metal layer and the dummy pattern as much as an interval, at which the parasitic capacitance is not increased, in the layout design step. In the exposing process using the mask manufactured in the step S40, the blockage layers, the upper blockage layers, and the lower blockage layers may not be actually displayed. Therefore, the above-described blockage layers, upper blockage layers, and lower blockage layers may not exist in the integrated circuit fabricated in the following steps.

In step S50, an operation of fabricating an integrated circuit may be performed. For example, a plurality of layers may be patterned using at least one mask manufactured in the step S40, so that the integrated circuit may be fabricated. As shown in FIG. 23, the step S50 may include steps S51 and S52.

In step S51, an FEOL process may be performed. The FEOL process may refer to a step of forming individual elements in a substrate. The individual elements may include a transistor, a capacitor, a resistor, and the like. The FEOL process may include a step of planarizing the substrate, a step of cleaning the substrate, a step of forming a trench, a step of forming an active region and an impurity region, a step of forming a gate line, and a step of forming a source and drain region. For example, the FEOL process may correspond to the step of forming the first layer F1 and the substrate 200 of FIGS. 6 and 7.

In step S52, a back-end-of-line (BEOL) process may be performed. The BEOL process may refer to a process of interconnecting the individual elements. For example, the BEOL process may include a step of silicidation of a gate and the source and drain region, a step of adding a dielectric, a planarization step, a step of forming a hole, a step of adding a metal layer, a step of forming a via, and a step of forming a passivation layer. For example, the BEOL process may correspond to the step of forming the second to eighth layers F2 to F8 of FIGS. 6 and 7.

An integrated circuit (IC) may be packaged after passing through step S52, and the IC may be used as a part of a variety of applications.

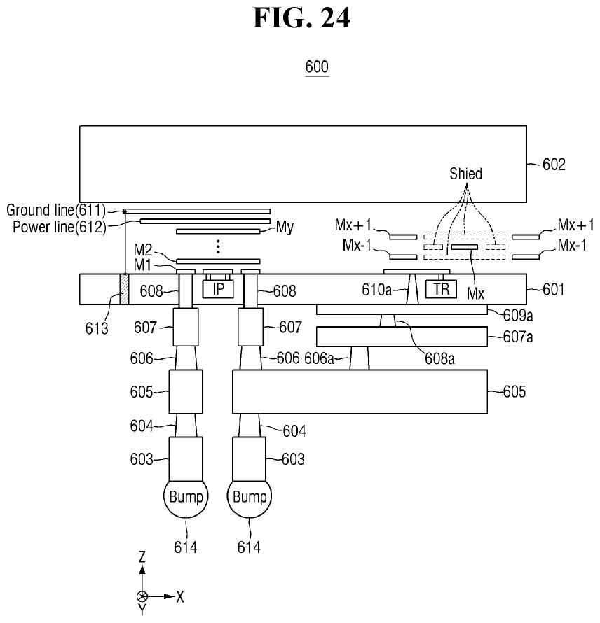

FIG. 24 is an exemplary schematic view illustrating a semiconductor device that includes the integrated circuit fabricated in accordance with FIG. 23.

Referring to FIG. 24, a semiconductor device 600 includes a substrate 601, a function block (Intellectual Property (IP)), a transistor TR, front side wiring lines M1 to My, Mx−1, Mx, and Mx+1, backside wiring lines 603, 605, 607, 607a, and 609a, backside wiring vias 604, 606, 606a, and 608a, through silicon vias (TSVs) 608 and 610a, bumps 614, and a cover 602.

The substrate 601 may be a silicon substrate or a silicon-on-insulator (SOI) substrate, and may be implemented as a P-type substrate or an N-type substrate in accordance with the embodiments, but is not limited thereto. The substrate 601 disposed on a plane defined by the first direction X and the second direction Y may have a front side and a backside, which are opposite to each other in the third direction Z. The front side of the substrate 601 may be disposed at a higher position in the third direction Z than the backside of the substrate 601.

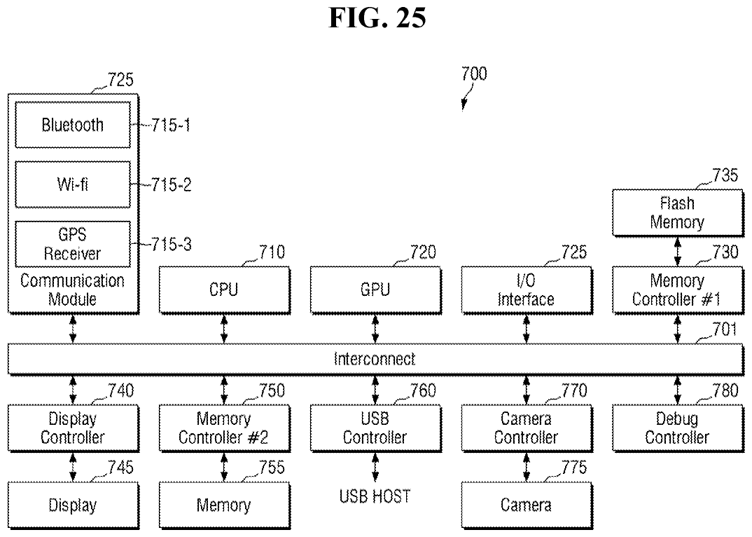

The function block IP and the transistor TR may be formed on the substrate 601. The function block IP may mean a function block that may be used in the integrated circuit (IC), a system on chip (SoC), or an application processor (AP). The function block IP will be described below with reference to FIG. 25. The transistor TR may correspond to the transistor TR shown in FIG. 4. For example, the transistor TR may include, but is not limited to, a fin-type transistor (FinFET) or a multi-bridge channel field effect transistor (MBCFET™).

The semiconductor device 600 may have a back side power delivery network (BSPDN) structure. The front side wiring lines M1 to My, Mx−1, Mx, and Mx+1 corresponding signal wires for transmitting a signal to the function block IP and the transistor TR may be disposed on the front side of the substrate 601, and the backside wiring lines 603, 605, 607, 607a, and 609a and the backside wiring vias 604, 606, 606a, and 608a, which transfer power to the function block IP and the transistor TR, may be disposed on the backside of the substrate 601. The backside wiring line 603 may be connected to the bumps 614 to receive the power from the outside. The TSVs 608 and 610a may transfer the power to the function block IP and the transistor TR by passing through the substrate 601 in the third direction Z. A ground line 611 disposed on the front side of the substrate 601 may be connected to a pad 613 formed to be embedded in the substrate 601 to transfer a ground voltage to the elements formed on the substrate 601. In addition, some power lines 612 may be disposed on the front side of the substrate 601 in the semiconductor device 600 having the BPDN structure. The cover 602 may include silicon, and may protect the front side wiring lines M1 to My, Mx−1, Mx, and Mx+1, the ground line 611 and the power line 612.

When a net of the semiconductor device 600 is selected in step S101 of FIG. 2, a net having a greater requirement to prevent performance degradation due to RC delay may be selected. For example, when a net corresponding to the transistor TR having a greater requirement to prevent performance degradation due to RC delay than a net corresponding to the function block IP, the net corresponding to the transistor TR may be selected to generate the blockage layer, the upper blockage layer, and the lower blockage layer according to some embodiments with respect to the metal layer Mx connected to the transistor TR.

Conventionally, as shown in FIG. 24, a shield is generated near the metal layer Mx to widen the interval between the metal layer and the dummy pattern, thereby preventing parasitic capacitance from being increased. However, a problem occurs in that another parasitic capacitance is generated and increased between the shield and the dummy pattern when the shield includes a conductive material such as metal. Therefore, in some embodiments, the blockage layer, the upper blockage layer, and the lower blockage layer may be generated near the metal layer Mx in a design step of the semiconductor device 600, thereby preventing performance of the metal layer Mx from being reduced. In addition, in the integrated circuit of the semiconductor device 600 completed through a semiconductor fabricating process, instead of the shield actually implemented to include a conductive material such as metal, the blockage layer, the upper blockage layer, and the lower blockage layer, which are generated only in the step of designing the layout of the integrated circuit to fabricate the semiconductor mask and are not actually implemented in the integrated circuit of the semiconductor device 600 completed through the semiconductor fabricating process, may be generated near the metal layer Mx in the semiconductor design process, so that an area occupied by the metal layer Mx and the metal layers Mx−1 and M+1 disposed near the metal layer Mx may be reduced, and the degree of integration of the semiconductor device 600 may be improved.

FIG. 25 is an exemplary block view illustrating the integrated circuit fabricated in accordance with FIG. 23.

Referring to FIG. 25, a semiconductor system 700 may include a structure of the integrated circuit fabricated in accordance with FIG. 23. The semiconductor system 700 may include an interconnect 701, a plurality of function blocks 710, 715, 720, 725, 730, 740, 750, 760, 770, and 780, a first memory device 735, a display 745, a second memory device 755, and a camera 775.

The semiconductor system 700 may be implemented as a PC or a mobile device. The mobile device may be implemented as a laptop computer, a mobile phone, a smart phone, a tablet PC, a personal digital assistant (PDA), an enterprise digital assistant (EDA), a digital still camera, a digital video camera, a portable multimedia player (PMP), a personal navigation device (PND) or a portable navigation device (PND), a handheld game console, a mobile Internet device (MID), a wearable computer, an Internet of Things (IoT) device, an Internet of Everything (IoE) device, a drone, or an e-book.

In some embodiments, the interconnect 701 and the plurality of function blocks 710, 715, 720, 725, 730, 740, 750, 760, 770, and 780 may be implemented in a system on chip. The function blocks 710, 715, 720, 725, 730, 740, 750, 760, 770, and 780 may correspond to the function block IP of FIG. 24 or the function block that includes the transistor TR of FIG. 24.

The CPU 710 may control the operation of each of the plurality of function blocks 715, 720, 725, 730, 740, 750, 760, 770, and 780 via the interconnect 701. For example, the interconnect 701 may be implemented as a bus. The communication module 715 may control data exchanged between an external communication device and the semiconductor system 700. For example, the communication module 715 may include a transceiver 715-1 for Bluetooth communication, a transceiver 715-2 for Wi-Fi communication, and a GPS receiver 715-3 for receiving GPS signals. Data processed by the communication module 715 may be transmitted to at least one of the plurality of function blocks 710, 715, 720, 725, 730, 740, 750, 760, 770, and 780 via the interconnect 701.

The GPU 720 may process graphics data. The I/O interface 725 may transmit data input from a user to the interconnect 701 or transmit the data transmitted from the interconnect 701 to the I/O device. The first memory controller 730 may write the data in the first memory device 735 or read the data from the first memory device 735 under the control of the CPU 710 or the GPU 720. For example, the first memory device 735 may be a non-volatile memory device. The display controller 740 may control the operation of the display 745 under the control of the CPU 710 or the GPU 720. For example, the display controller 740 may transmit display data to the display 745.

The second memory controller 750 may write the data in the second memory device 755 or read the data from the second memory device 755 under the control of the CPU 710 or the GPU 720. For example, the second memory device 755 may be a volatile memory device.

The USB controller 760 may transmit or receive the data to or from a USB host. The camera controller 770 may process the data output from the camera 775 and transmit the processed data to the interconnect 701. The debug controller 780 may control debugging of the semiconductor system 700.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

What is claimed is:

1. An integrated circuit design system using a computing system, the integrated circuit design system comprising:
a memory configured to store an instruction; and
a processor configured to execute the instruction to cause the integrated circuit design system to design an integrated circuit,
wherein the integrated circuit includes a substrate, a front end of line (FEOL) in at least a portion of the substrate and on the substrate, and a back end of line (BEOL) formed on the FEOL, and
wherein when the processor executes the instruction to cause the integrated circuit design system to design the integrated circuit, the processor is configured to:
select a first metal layer included in the BEOL and disposed at a first level from the substrate;
generate a first blockage layer disposed at the first level and surrounding the first metal layer;
generate at least one first upper blockage layer disposed at a level higher than the first level from the substrate; and
generate at least one first lower blockage layer disposed at a level lower than the first level from the substrate.

2. The integrated circuit design system of claim 1, wherein when the processor generates the first upper blockage layer, the processor is configured to:
generate a second blockage layer disposed at a second level higher than the first level from the substrate; and
generate a third blockage layer disposed at a third level higher than the second level from the substrate.

3. The integrated circuit design system of claim 2, wherein when the processor executes the instruction to cause the integrated circuit design system to design the integrated circuit, the processor is further configured to:
generate a first dummy pattern at the second level; and
generate a second dummy pattern at the third level,
wherein the first and second dummy patterns do not overlap the first metal layer in a plan view.

4. The integrated circuit design system of claim 2, wherein when the processor generates the first lower blockage layer, the processor is configured to generate a fourth blockage layer disposed at a fourth level, which is lower than the first level from the substrate.

5. The integrated circuit design system of claim 4, wherein when the processor generates the first lower blockage layer, the processor is further configured to generate a fifth blockage layer disposed at a fifth level, which is lower than the fourth level from the substrate.

6. The integrated circuit design system of claim 5, when the processor executes the instruction to cause the integrated circuit design system to design the integrated circuit, the processor is further configured to:
generate a third dummy pattern at the fourth level; and
generate a fourth dummy pattern at a fifth level,
wherein the third and fourth dummy patterns do not overlap the first metal layer in a plan view.

7. The integrated circuit design system of claim 1,
wherein the integrated circuit includes a passive element, and
wherein the passive element includes a second metal layer included in the BEOL, disposed at the first level from the substrate and not overlapped with the first metal layer, and a third metal layer included in the BEOL and disposed at a second level higher than the first level from the substrate, and
wherein the second metal layer and the third metal layer are connected to each other through a via.

8. The integrated circuit design system of claim 7, wherein when the processor executes the instruction to cause the integrated circuit design system to design the integrated circuit, the processor is further configured to:
generate a second blockage layer disposed at the first level and surrounding the second metal layer; and
generate a third blockage layer disposed at the second level, and surrounding the third metal layer.

9. The integrated circuit design system of claim 8, wherein when the processor executes the instruction to cause the integrated circuit design system to design the integrated circuit, the processor is further configured to:
generate at least one second upper blockage layer disposed at a level higher than the second level from the substrate; and
generate at least one second lower blockage layer disposed at a level lower than the first level from the substrate.

10. The integrated circuit design system of claim 9,
wherein the second upper blockage layer overlaps at least a portion of the second metal layer and the third metal layer in a plan view, and
wherein the second lower blockage layer overlaps at least a portion of the second metal layer and the third metal layer in a plan view.

11. The integrated circuit design system of claim 10, wherein when the processor generates the second upper blockage layer, the processor is further configured to:
generate a third blockage layer disposed at a third level, which is higher than the second level from the substrate; and
generate a fourth blockage layer disposed at a fourth level, which is higher than the third level from the substrate.

12. The integrated circuit design system of claim 11, wherein when the processor generates the second lower blockage layer, the processor is further configured to:
generate a fifth blockage layer disposed at a fifth level, which is lower than the first level from the substrate; and
generate a sixth blockage layer disposed at a sixth level, which is lower than the fifth level from the substrate.

13. An integrated circuit design system using a computing system, the integrated circuit design system comprising:
a memory configured to store an instruction; and
a processor configured to execute the instruction to cause the integrated circuit design system to design an integrated circuit,
wherein the integrated circuit includes a substrate, a front end of line (FEOL) in at least a portion of the substrate and on the substrate, a back end of line (BEOL) formed on the FEOL, and a passive element formed in the BEOL,
wherein the passive element includes a first metal layer included in the BEOL and disposed at a first level from the substrate, and a second metal layer included in the BEOL, disposed at a second level higher than the first level from the substrate and connected to the first metal layer through a via, and
wherein when the processor executes the instruction to cause the integrated circuit design system to design the integrated circuit, the processor is configured to:
select the first metal layer;
generate a first blockage layer disposed at the first level, surrounding the first metal layer;
generate a second blockage layer disposed at the second level, surrounding the second metal layer;
generate at least one upper blockage layer disposed at a level higher than the second level from the substrate; and
generate at least one lower blockage layer disposed at a level lower than the first level from the substrate.

14. The integrated circuit design system of claim 13, wherein when the processor generates the upper blockage layer, the processor is configured to:
generate a third blockage layer disposed at a third level, which is higher than the second level from the substrate; and
generate a fourth blockage layer disposed at a fourth level, which is higher than the third level from the substrate.

15. The integrated circuit design system of claim 14, wherein when the processor executes the instruction to cause the integrated circuit design system to design the integrated circuit, the processor is further configured to:
insert a first dummy pattern into the third level,
wherein the first dummy pattern does not overlap the third blockage layer.

16. The integrated circuit design system of claim 15, wherein the first dummy pattern overlaps at least a portion of the first metal layer and the second metal layer in a plan view.

17. The integrated circuit design system of claim 13, wherein when the processor generates the lower blockage layer, the processor is configured to:
generate a fifth blockage layer disposed at a fifth level, which is lower than the first level from the substrate.

18. The integrated circuit design system of claim 17, wherein when the processor generates the lower blockage layer, the processor is further configured to generate a sixth blockage layer disposed at a sixth level, which is lower than the fifth level from the substrate.

19. A computing system comprising:
a memory configured to store an instruction; and
a processor configured to execute the instruction to cause the computing system to design an integrated circuit,
wherein the integrated circuit includes a substrate, a front end of line (FEOL) formed in at least a portion of the substrate and on the substrate and a back end of line (BEOL) formed on the FEOL,
wherein when the processor executes the instruction to cause the computing system to design the integrated circuit, the processor is configured to:
select a first metal layer included in the BEOL and disposed at a first level from the substrate;
generate a first blockage layer disposed at the first level, and surrounding the first metal layer;
generate at least one first upper blockage layer disposed at a level higher than the first level from the substrate;
generate at least one first lower blockage layer disposed at a level lower than the first level from the substrate;
select a passive element, which includes a second metal layer that is included in the BEOL, is disposed at the first level from the substrate, and does not overlap the first metal layer, and a third metal layer that is included in the BEOL, is disposed at a second level that is higher than the first level from the substrate, and is connected to the second metal layer through a via;
generate a second blockage layer disposed at the first level, and surrounding the second metal layer;
generate a third blockage layer disposed at the second level, and surrounding the third metal layer;
generate at least one second upper blockage layer disposed at a level higher than the second level from the substrate; and
generate at least one second lower blockage layer disposed at a level lower than the first level from the substrate.

20. The computing system of claim 19, wherein, when the instruction is executed by the processor, the processor is further configured to:
insert a first dummy pattern near the first metal layer at the first level;
insert a second dummy pattern into a level higher than the first level from the substrate; and
insert a third dummy pattern into a level lower than the first level from the substrate.
